(19) United States
(12) Patent Application Publication
(10) Pub. No.: US 2006/0009552 A1
(43) Pub. Date: Jan. 12, 2006

(54) Pressure-sensitive adhesive

(75) Inventors: Marc Husemann, Hamburg (DE); Thilo Dollase, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 11/116,568

(22) Filed: Apr. 28, 2005

(30) Foreign Application Priority Data
Jul. 8, 2004 (DE) 10 2004 033 242.8

(51) Int. Cl. C08K 3/00

(52) U.S. Cl. 524/80; 525/88

(57) ABSTRACT

The invention relates to a pressure-sensitive adhesive. It is envisaged that this pressure-sensitive adhesive comprises at least 50% by weight of at least one block copolymer formed from a comonomer composition comprising acrylic acid derivatives or methacrylic acid derivatives, the block copolymer comprising a unit P(A)-P(B)-P(A) comprising a polymer block P(B) and two polymer blocks P(A); the polymer blocks P(A) independently of one another representing homopolymer or copolymer blocks of monomers A, the polymer blocks P(A) each having a softening temperature in the range from +20° C. to +175° C.; P(B) representing a homopolymer or copolymer block of monomers B, the polymer block P(B) having a softening temperature in the range from −130° C. to +10° C.; and the polymer blocks P(A) and P(B) being not homogeneously miscible with one another.

The invention relates to a pressure-sensitive adhesive (PSA) and to its use. It relates in particular to a PSA which by virtue of its diesel resistance, its solvent resistance and its low outgassing or fogging behaviour can be used in the automotive sector.

Solvent-resistant PSAs, especially diesel-resistant PSAs, are required in the automotive sector for a variety of applications, particularly for use in the engine area. In addition to the diesel and solvent resistance the requirements in the automotive industry are continually increasing. For applications as cable bandaging tapes, for example, additional requirements are that the self-adhesive tapes employed can be used in a wide temperature range, exhibit very low outgassing/fogging or else adhere very well to new cable insulating materials (such as polyethylene or an ethylene-chlorotrifluoroethylene copolymer, for example).

Meeting these requirements requires special PSAs. At the present time natural rubber adhesives are frequently employed for such applications. U.S. Pat. No. 5,681,654, for example, describes a self-adhesive tape whose PSA is a rubber adhesive which is crosslinked via sulphur. Natural rubbers, however, have unfavourable ageing characteristics, particularly at the kind of elevated temperatures which may well prevail in the engine area.

Therefore a trend which is evident in the automotive industry is to make increased use of PSAs based on acrylate copolymers. Acrylate PSAs generally have the advantage of being useful over a relatively wide temperature range, of being very stable to weathering and also of possessing resistance to solvents even after crosslinking. Moreover, the ageing characteristics are found to be not critical.

In order to ensure the requirement for low outgassing, acrylate hotmelt PSAs have been used to an increased extent. Products which have become established here include in particular the hotmelt PSAs from BASF AG which are sold commercially under the name UV acResins™ 258. These products have the advantage of being readily processable from the melt and in addition, as a result of the UV crosslinkability, are solvent resistant. DE 198 07 752 describes the crosslinking of such acrylate hotmelts for cable bandaging tapes. The fogging characteristics are emphasized there as a particular, positive property.

Nevertheless these acrylate hotmelt PSAs also possess drawbacks. As a result of the UV crosslinking there is an increase in the shear strength of the PSA, but volatile fragments are formed as well, and lead to instances of odour nuisance. Therefore there is no fogging, but the PSAs have a very unpleasant smell after UV crosslinking. These qualities are not desired by carmakers. Moreover, these PSAs lack great shear strength, since the initial molecular weight of the UV acResins™ is relatively low and hence difficult to increase. This as well may become a drawback, since the cable looms in the automotive industry are taking on ever greater dimensions as a result of the increasing electronic development. Stringent requirements will be imposed here in the future as well, since the desire is to wind these cable looms very tightly and as a result of the high tension there is likewise an increase in the requirement imposed on the internal cohesion of the PSA.

A further desire is to make the production operation significantly more efficient. In the case of the conventional cable bandaging tapes, application takes place either from solution and then crosslinking takes place thermally or by means of actinic radiation. Besides the low degree of environment-friendliness, this operation is not very efficient. The reason for this is that blister-free solvent evaporation in the drying tunnel is possible only in conjunction with low belt speeds, i.e. coating speeds. Although the alternative hotmelt process has the advantage of the high coating speeds, it requires an additional crosslinking step, which gives rise in turn to costs. At very high coating speeds there is a need for a large number of UV lamps in order to introduce the necessary UV dose for crosslinking.

It is an object of the invention to eliminate the disadvantages according to the state of the art. The aim in particular is to specify a PSA which can be prepared very efficiently, which in comparison with the state of the art has improved properties in respect of diesel resistance, outgassing behaviour and cohesion, and which is therefore suitable for use in the automotive sector.

This object is achieved through the features of claims 1, 20 and 21. Advantageous embodiments of the invention are apparent from the features of claims 2 to 19 and 22.

The invention provides a pressure-sensitive adhesive comprising at least 50% by weight of at least one block copolymer formed from a comonomer composition comprising acrylic acid derivatives or methacrylic acid derivatives,
the block copolymer comprising a unit P(A)-P(B)-P(A) comprising a polymer block P(B) and two polymer blocks P(A);
the polymer blocks P(A) independently of one another representing homopolymer or copolymer blocks of monomers A, the polymer blocks P(A) each having a softening temperature in the range from +20° C. to +175° C.;
P(B) representing a homopolymer or copolymer block of monomers B, the polymer block P(B) having a softening temperature in the range from −130° C. to +10° C.; and
the polymer blocks P(A) and P(B) being not homogeneously miscible with one another.

The PSA of the invention possesses on storage for 12 hours at 120° C. an outgassing value of less than 2000 μg/g PSA, passes test method A for diesel resistance, and is solvent-resistant as tested by test method F.

A feature of the PSA of the invention is that it is based on at least one acrylate block copolymer which meets the requirements specified above and is distinguished in particular by the following criteria:
possibility of using a large number of monomers for synthesizing the PSA, so that a broad pallette of pressure-sensitive adhesion properties can be set by means of the chemical composition;
preparation of highly cohesive PSA layers without an additional crosslinking step in the production operation;
possibility of choice in the use of comonomers, allowing control over the thermal shear strength, and in particular a persistently good cohesion and thus holding power at high temperatures (>+60° C.).

The unit P(A)-P(B)-P(A) is also referred to below as a triblock copolymer.

The invention is described in more detail below with reference to the drawings, of which

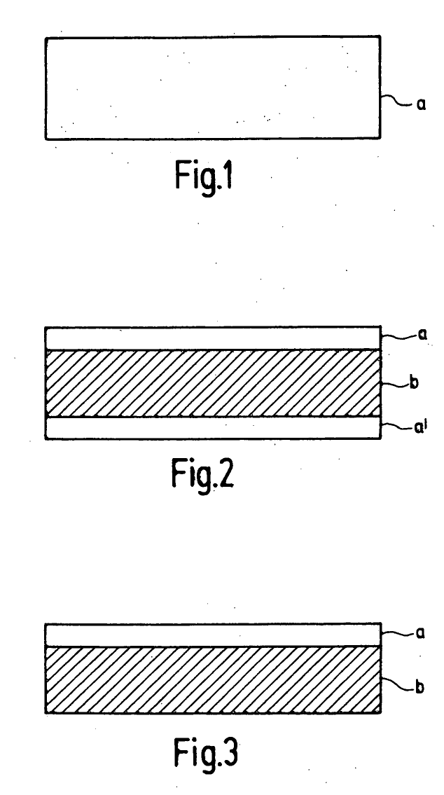

FIG. 1 shows a cross-sectional representation of an adhesive tape of single-layer construction, composed of an inventive PSA;

FIG. 2 shows a cross-sectional representation of an adhesive tape of three-layer construction, having layers of inventive PSAs; and

FIG. 3 shows a cross-sectional representation of an adhesive tape of two-layer construction, having one layer of an inventive PSA.

The invention relates accordingly to diesel-resistant PSAs having a low outgassing behaviour and containing at least 50% of a block copolymer as defined in claim 1.

The invention accordingly provides pressure-sensitive adhesives which in storage for 12 hours at 120° C. possess an outgassing value of less than 2000 μg/g of adhesive, which pass test method A for diesel resistance, which are solvent-resistant as tested by test method F and which comprise at least one block copolymer which is based at least in part on (meth)acrylic acid derivatives, the block copolymer or copolymers comprising at least the unit P(A)-P(B)-P(A) comprising at least one polymer block P(B) and at least two polymer blocks P(A), and where
P(A) independently of one another represent homopolymer or copolymer blocks of monomers A, the polymer blocks P(A) each having a softening temperature in the range from +20° C. to +175° C.,
P(B) represents a homopolymer or copolymer block of monomers B, the polymer block P(B) having a softening temperature in the range from −130° C. to +10° C., and
the polymer blocks P(A) and P(B) being not homogeneously miscible with one another.

In the text below, the polymer blocks P(A) are also referred to as “hard blocks” and the polymer blocks P(B) as “elastomer blocks”.

The softening temperature in this context is the glass transition temperature in the case of amorphous systems and the melting temperature in the case of semi-crystalline polymers. Glass temperatures are reported as results of quasistatic methods such as differential scanning calorimetry (DSC), for example.

PSAs which have proven to be particularly advantageous in the sense of the invention are those which on storage for 12 hours at 120° C. possess an outgassing value of less than 2000 μg/g of adhesive, which pass test method A for diesel resistance and for which the structure of the block copolymer or copolymers can be described by one or more of the following general formulae:
P(A)-P(B)-P(A) (I)
P(B)-P(A)-P(B)-P(A)-P(B) (II)
[P(B)-P(A)]ₙX (III)
[P(B)-P(A)]ₙX[P(A)]ₘ (IV),
wherein n=3 to 12, m=3 to 12, and X represents a polyfunctional branching unit, i.e., a chemical building block via which different polymer arms are linked to one another,
wherein the polymer blocks P(A) independently of one another represent homopolymer or copolymer blocks of the monomers A, the polymer blocks P(A) each having a softening temperature in the range from +20° C. to +175° C., and
wherein the polymer blocks P(B) independently of one another represent homopolymer or copolymer blocks of the monomers B, the polymer blocks P(B) each having a softening temperature in the range from −130° C. to +10° C.

The polymer blocks P(A) can comprise polymer chains of a single monomer type from group A, or copolymers of monomers of different structures from group A. In particular, the monomers A used can vary in their chemical structure and/or in the side chain length. The polymer blocks therefore span the range between completely homogeneous polymers, via polymers composed of monomers of identical chemical parent structure but differing in chain length, and those with the same number of carbon atoms but different isomerism, through to randomly polymerized blocks composed of monomers of different lengths with different isomerism from group A. The same applies to the polymer blocks P(B) in respect of the monomers from group B.

The unit P(A)-P(B)-P(A) may be either symmetrical [corresponding to P¹(A)-P(B)-P²(A) where P¹(A)=P²(A)] or asymmetric [corresponding, for instance, to the formula P³(A)-P(B)-P⁴(A) where P³(A)≠P⁴(A), but where both P³(A) and P⁴(A) are each polymer blocks as defined for P(A)] in construction.

An advantageous embodiment of the PSA of the invention is one in which the block copolymers have a symmetrical construction such that there are polymer blocks P(A) identical in chain length and/or chemical structure and/or there are polymer blocks P(B) identical in chain length and/or chemical structure.

P³(A) and P⁴(A) may differ in particular in their chemical composition and/or in their chain length.

As monomers for the elastomer block P(B) it is advantageous to use acrylic/acrylate monomers. For this purpose it is possible in principle to use all acrylic/acrylate compounds which are familiar to the skilled worker and are suitable for synthesizing polymers. It is preferred to choose monomers which, even in combination with one or more further monomers, produce polymer block P(B) glass transition temperatures of less than +10° C. Accordingly, it is possible with preference to choose vinyl monomers.

The polymer blocks P(B) are advantageously prepared using

(a) from 75 to 100% by weight of acrylic and/or methacrylic acid derivatives of the formula
CH₂═CH(R¹)(COOR²) (V)
where R¹ is H or CH₃ and R² is H or linear, branched or cyclic, saturated or unsaturated, alkyl radicals having from 1 to 30, preferably from 4 to 18, carbon atoms; and
(b) from 0 to 25% by weight of vinyl compounds (VI), which preferably contain functional groups.

Acrylic monomers used with great preference within the meaning of compound (V) as components of polymer blocks P(B) comprise acrylic and methacrylic esters With alkyl groups composed of from 4 to 18 carbon atoms. Specific examples of such compounds, without wishing to be restricted by this enumeration, include n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, branched isomers thereof, such as 2-ethylhexyl acrylate and isooctyl acrylate, for example, and also cyclic monomers such as cyclohexyl acrylate or norbornyl acrylate and isobornyl acrylate, for example.

As an option, it is also possible to use vinyl monomers from the following groups as monomers within the definition (VI) for polymer blocks P(B): vinyl esters, vinyl ethers, vinyl halides, vinylidene halides, and also vinyl compounds which comprise aromatic cycles and heterocycles in the a position. Here too, mention may be made, by way of example, of selected monomers which can be used in accordance with the invention: vinyl acetate, vinylformamide, vinylpyridine, ethyl vinyl ether, 2-ethylhexyl vinyl ether, butyl vinyl ether, vinyl chloride, vinylidene chloride, and acrylonitrile.

Particularly preferred examples of suitable vinyl-containing monomers as defined for (VI) for the elastomer block P(B) further include hydroxyethyl acrylate, hydroxypropyl acrylate, hydroxyethyl methacrylate, hydroxypropyl methacrylate, N-methylolacrylamide, acrylic acid, methacrylic acid, allyl alcohol, maleic anhydride, itaconic anhydride, itaconic acid, benzoin acrylate, acrylated benzophenone, acrylamide, and glycidyl methacrylate, to name but a few.

In one preferred embodiment of the diesel-resistant PSAs of the invention, one or more of the polymer blocks contain one or more grafted-on side chains. No restriction is imposed as to whether such systems are obtained by means of a graft-from process (polymerizational attachment of a side chain starting from an existing polymer backbone) or graft-to process (attachment of polymer chains to a polymer backbone by means of polymer-analogous reactions).

For preparing block copolymers of this type it is possible in particular to use, as monomers B, monomers functionalized in such a way as to allow a graft-from process for the grafting on of side chains. Particular mention may be made here of acrylic and methacrylic monomers which carry halogen functionalization or functionalization provided by any other functional groups which permit, for example, an ATRP (atom transfer radical polymerization) process. In this context, mention may also be made of the possibility of introducing side chains into the polymer chains in a targeted way via macromonomers. The macromonomers may in turn be constructed in accordance with the monomers B.

In one specific embodiment of this invention, the polymer blocks P(B) have had incorporated into them one or more functional groups which permit radiation-chemical crosslinking of the polymer blocks, in particular by means of UV irradiation or irradiation with rapid electrons. With this objective, monomer units which can be used include, in particular, acrylic esters containing an unsaturated alkyl radical having from 3 to 18 carbon atoms and at least one carbon-carbon double bond. Suitable acrylates modified with double bonds include, with particular advantage, allyl acrylate and acrylated cinnamates. Besides acrylic monomers it is also possible with great advantage, as monomers for the polymer block P(B), to use vinyl compounds containing double bonds which are not reactive during the (free-radical) polymerization of the polymer blocks P(B). Particularly preferred examples of such comonomers are isoprene and/or butadiene, and also chloroprene.

Starting monomers for the polymer blocks P(A) are preferably selected such that the resulting polymer blocks P(A) are imiscible with the polymer blocks P(B) and, correspondingly, microphase separation occurs. Advantageous examples of compounds used as monomers A include vinylaromatics, which may also optionally be alkylated, methyl methacrylate, cyclohexyl methacrylate, isobornyl methacrylate, and isobornyl acrylate.

Particularly preferred examples are methyl methacrylate and styrene, although this enumeration makes no claim to completeness.

In addition, however, the polymer blocks P(A) may also be constructed in the form of a copolymer which can consist of at least 75% of the above monomers A, leading to a high softening temperature, or of a mixture of these monomers, but can also contain up to 25% of monomers B, which leads to a reduction in the softening temperature of the polymer block P(A). In this sense mention may be made, by way of example but not exclusively, of alkyl acrylates, which are defined in accordance with the structure (V) and the comments made in relation thereto.

In another embodiment of the inventive PSA, polymer blocks P(A) and/or P(B) are functionalized in such a way that a thermally initiated crosslinking can be accomplished. Crosslinkers which can be chosen favorably include: epoxides, aziridines, isocyanates, polycarbodiimides, and metal chelates, to name but a few.

One preferred characteristic of the block copolymers of the invention is that their molar mass Mn is between about 10 000 and about 600 000 g/mol, preferably between. 30 000 and 400 000 g/mol, with particular preference between 50 000 g/mol and 300 000 g/mol. The polymer block P(A) fraction is advantageously between 5 and 40 percent by weight of the overall block copolymer, preferably between 7.5 and 35 percent by weight, with particular preference between 10 and 30 percent by weight. The polydispersity of the block copolymer is preferably less than 3, being the quotient formed from the mass average M_{w} and number average Mₙ of the molar mass distribution.

In a very advantageous procedure, the ratios of the chain lengths of the block copolymers P(A) to those of the block copolymers P(B) are chosen such that the block copolymers P(A) are present as a disperse phase (“domains”) in a continuous matrix of the polymer blocks P(B). This is preferably the case at a polymer blocks P(A) content of less than approximately 25% by weight. The formation of hexagonally packed cylindrical domains of the polymer blocks P(A) is likewise possible within the inventive context. An asymmetric design of the triblock copolymers, with the block lengths of the terminal polymer blocks P(A) in linear systems being different, allows the polymer blocks P(A) content, in which the system still has a sphere morphology, to be increased to above approximately 30% by weight. This morphology is particularly preferred when it is necessary to increase the internal strength of the pressure sensitive adhesive, and also for improving the mechanical properties.

Moreover, it may be advantageous to use blends of the abovementioned block copolymers with diblock copolymers P(A)-P(B), the monomers used to prepare the corresponding polymer blocks P(A) and P(B) possibly being the same as those used above. It may further be of advantage to add polymers P′(A) and/or P′(B) to the PSA composed of the block copolymers, especially of triblock copolymers (I), or of a block copolymer/diblock copolymer blend, for the purpose of improving its properties.

The invention further provides, accordingly, a pressure-sensitive adhesive which on storage for 12 hours at 120° C. possesses an outgassing value of less than 2000 μg/g of adhesive, which passes test method A for diesel resistance and which comprises a blend of one or more block copolymers according to claim 1 with a diblock copolymer P(A)-P(B),
where the polymer blocks P(A) (of the individual diblock copolymers) independently of one another represent homopolymer or copolymer blocks of the monomers A, the polymer blocks P(A) each having a softening temperature in the range from +20° C. to +175° C.,
where the polymer blocks P(B) (of the individual diblock copolymers) independently of one another represent homopolymer or copolymer blocks of the monomers B, the polymer blocks P(B) each having a softening temperature in the range from −130° C. to +10° C.,
   and/or with polymers P′(A) and/or P′(B),
where the polymers P′(A) represent homopolymers and/or copolymers of the monomers A, the polymers P′(A) each having a softening temperature in the range from +20° C. to +175° C.,
where the polymers P′(B) represent homopolymers and/or copolymers of the monomers B, the polymers P′(B) each having a softening temperature in the range from −130° C. to +10° C.,
where the polymers P′(A) and P′(B) are preferably miscible with the polymer blocks P(A) and P(B) respectively.

Where both polymers P′(A) and polymers P′(B) have been admixed, they are advantageously chosen such that the polymers P′(A) and P′(B) are not homogeneously miscible with one another.

As monomers for the diblock copolymers P(A)-P(B), and for the polymers P′(A) and P′(B) respectively, it is preferred to use the monomers already mentioned from groups A and B.

The diblock copolymers preferably have a molar mass Mn of between 5 000 and 600 000 g/mol, more preferably between 15 000 and 400 000 g/mol, with particular preference between 30 000 and 300 000 g/mol. They advantageously possess a polydispersity D=M_{w}/Mₙ of not more than 3. It is advantageous if the fraction of the: polymer blocks P(A) in the composition of the diblock copolymer is between 3 and 50% by weight, preferably between 5 and 35% by weight.

Typical concentrations in which diblock copolymers are used in the blend are up to 250 parts by weight per 100 parts by weight of higher block copolymers comprising the unit P(A)-P(B)-P(A). The polymers P′(A) and P′(B) respectively may be constructed as homopolymers and also as copolymers. In accordance with the comments made above, they are advantageously chosen so as to be compatible with the block copolymers P(A) and P(B) respectively. The chain length of the polymers P′(A) and P′(B) respectively is preferably chosen such that it does not exceed that of the polymer block which is preferably miscible and/or associable with it, and is advantageously 10% lower, very advantageously 20% lower, than said length. The B block may also be chosen so that its length does not exceed half of the length of the polymer block P(B) of the triblock copolymer.

To prepare the block copolymers of the invention it is possible in principle to use all polymerizations which proceed in accordance with a controlled-growth or living mechanism, including combinations of different controlled polymerization techniques. Without possessing any claim to completeness, mention may be made here, by way of example, besides anionic polymerization, of ATRP, nitroxide/TEMPO-controlled polymerization, or, more preferably, the RAFT process; in other words, particularly those processes which allow control over the block lengths, polymer architecture or else, but not necessarily, the tacticity of the polymer chain.

Free-radical polymerizations can be conducted in the presence of an organic solvent or in the presence of water, or in mixtures of organic solvents and/or organic solvents with water, or without solvent. It is preferred to use as little solvent as possible. Depending on conversion and temperature, the polymerization time for free-radical processes is typically between 4 and 72 h.

In the case of solution polymerization, the solvents used are preferably esters of saturated carboxylic acids (such as ethyl acetate), aliphatic hydrocarbons (such as n-hexane, n-heptane or cyclohexane), ketones (such as acetone or methyl ethyl ketone), special boiling point spirit, aromatic solvents such as toluene or xylene, or mixtures of the aforementioned solvents. For polymerization in aqueous media or in mixtures of organic and aqueous solvents, it is preferred to add emulsifiers and stabilizers for the polymerization.

Where a free-radical polymerization method is employed, as polymerization initiators it is of advantage to use customary radical-forming compounds such as, for example, peroxides, azo compounds, and peroxosulphates. Initiator mixtures also possess outstanding suitability.

In an advantageous procedure, radical stabilization is effected using nitroxides of type (VIIa) or (VIIb): 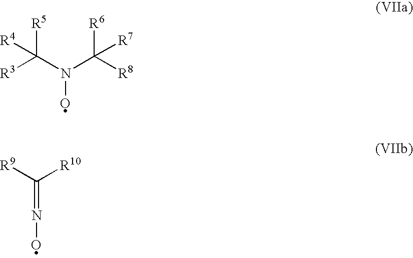
where R³, R⁴, R⁵, R⁶, R⁷, R⁸, R⁹, and R¹⁰, independently of one another, denote the following compounds or atoms:
i) halides, such as chlorine, bromine or iodine;
ii) linear, branched, cyclic, and heterocyclic hydrocarbons having from 1 to 20 carbon atoms, which can be saturated, unsaturated or aromatic;
iii) esters —COOR¹¹, alkoxides —OR¹² and/or phosphonates —PO(OR¹³)₂, in which R¹¹, R¹², and R¹³ stand for radicals from group ii).

Compounds of formula (VIIa) or (VIIb) may also be attached to polymer chains of any kind (primarily in the sense that at least one of the abovementioned radicals constitutes such a polymer chain) and can therefore be used as macroradicals or macroregulators to construct the block copolymers.

More preferred as controlled regulators for the polymerization are compounds of the following type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide

U.S. Pat. No. 4,581,429 A discloses a controlled-growth radical polymerization process initiated using a compound of the formula R^{I}R^{II}N—O—Y in which Y is a free radical species which is able to polymerize unsaturated monomers. The reactions, however, generally have low conversions. The particular problem is the polymerization of acrylates, which proceeds only to very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process using very specific radical compounds such as, for example, phosphorus-containing nitroxides which are based on imidazolidine. WO 98/44008 A1 discloses specific nitroxyls based on morpholines, piperazinones, and piperazinediones. DE 199 49 352 A1 describes heterocyclic alkoxyamines as regulators in controlled-growth radical polymerizations. Corresponding further developments of the alkoxyamines and/or of the corresponding free nitroxides improve the efficiency for preparing polyacrylates (Hawker, contribution to the National Meeting of the American Chemical Society, Spring 1997; Husemann, contribution to the IUPAC World Polymer Meeting 1998, Gold Coast).

As a further controlled polymerization method, it is possible advantageously to use atom transfer radical polymerization (ATRP) to synthesize the block copolymers, with preferably monofunctional or difunctional secondary or tertiary halides being used as initiator and, to abstract the halide(s), complexes of Cu, Ni, Fe, Pd, Pt, Ru, Os, Rh, Co, Ir, Ag or Au (EP 0824 111 A1; EP826698A1; EP824 11A1; EP841 346A1; EP850 957 A1). The different possibilities of ATRP are also described in the documents U.S. Pat. No. 5,945,491 A, U.S. Pat. No. 5,854,364 A, and U.S. Pat. No. 5,789,487 A.

It is also possible with advantage to prepare the block copolymer of the invention by means of an anionic polymerization. In this case the reaction medium used preferably comprises inert solvents, such as aliphatic and cycloaliphatic hydrocarbons, for example, or else aromatic hydrocarbons.

The living polymer is generally represented by the structure P_{L}(A)-Me, in which Me is a metal from group I of the Periodic Table, such as lithium, sodium or potassium, for example, and PL(A) is a growing polymer block made up of the monomers A. The molar mass of the polymer block being prepared is determined by the ratio of initiator concentration to monomer concentration. In order to construct the block structure, first of all the monomers A are added for the construction of a polymer block P(A), then, by adding the monomers B, a polymer block P(B) is attached, and subsequently, by again adding monomers A, a further polymer block P(A) is polymerized on, so as to form a triblock copolymer P(A)-P(B)-P(A). Alternatively, P(A)-P(B)-M can be coupled by means of a suitable difunctional compound. In this way, starblock copolymers (P(B)-P(A))ₙ as well are obtainable. Examples of suitable polymerization initiators include n-propyllithium, n-butyllithium, sec-butyllithium, 2-naphthyllithium, cyclohexyllithium, and octyllithium, but this enumeration makes no claim to completeness. Furthermore, initiators based on samarium complexes are known for the polymerization of acrylates (Macromolecules, 1995, 28, 7886) and can be used here.

It is also possible, moreover, to use difunctional initiators, such as 1,1,4,4-tetraphenyl-1,4-dilithiobutane or 1,1,4,4-tetraphenyl-1,4-dilithioisobutane. Coinitiators may likewise be used. Suitable coinitiators include lithium halides, alkali metal alkoxides, and alkylaluminium compounds. In one very preferred version, the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

A very preferred preparation process conducted is a variant of the RAFT polymerization (reversible addition-fragmentation chain transfer polymerization). The polymerization process is described in detail, for example, in the documents WO 98/01478 A1 and WO 99/31144 A1. Suitable with particular advantage for the preparation of triblock copolymers are trithiocarbonates of the general structure R^{III}—S—C(S)—S—R^{III} (Macro-molecules 2000, 33, 243-245), by means of which, in a first step, monomers for the endblocks P(A) are polymerized. Then, in a second step, the middle block P(B) is synthesized. Following the polymerization of the endblocks P(A), the reaction can be terminated and reinitiated. It is also possible to carry out polymerization sequentially without interrupting the reaction. In one very advantageous variant, for example, the trithiocarbonates (VIII) and (IX) or the thio compounds (X) and (XI) are used for the polymerization, it being possible for Φ to be a phenyl ring, which can be unfunctionalized or functionalized by alkyl or aryl substituents attached directly or via ester or ether bridges, or can be a cyano group, or can be a saturated or unsaturated aliphatic radical. The phenyl ring φ may optionally carry one or more polymer blocks, examples being polybutadiene, polyisoprene, polychloroprene or poly(meth)acrylate, which can be constructed in accordance with the definition of P(A) or P(B), or polystyrene, to name but a few. Functionalizations may, for example, be halogens, hydroxyl groups, epoxide groups, groups containing nitrogen or sulphur, with this list making no claim to completeness.

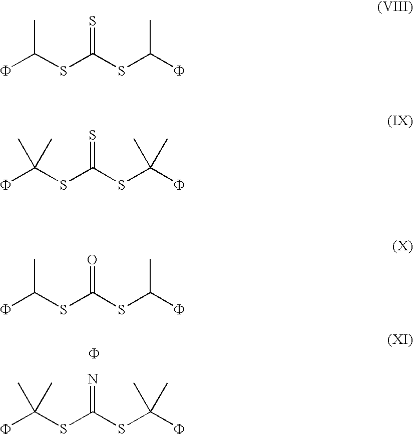

It is also possible to employ thioesters of the general structure R^{IV}—C(S)—S—R^{V}, especially in order to prepare asymmetric systems. R^{IV} and R^{V} can be selected independently of one another, and R^{IV} can be a radical from one of the following groups i) to iv) and R^{V} a radical from one of the following groups i) to iii):
i) C₁ to C₁₈ alkyl, C₂ to C₁₈ alkenyl, C₂ to C₁₈ alkynyl, each linear or branched; aryl-, phenyl-, benzyl-, aliphatic and aromatic heterocycles.
ii) —N H₂, —NH—R^{VI}, —NR^{VI}R^{VII}, —NH—C(O)—R^{VI}, —NR^{VI}—C(O)—R^{VII}, —NH—C(S)—R^{VI}, —NR^{VI}—C(S)—R^{VII}, 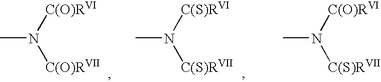
   with R^{VI} and R^{VII} being radicals selected independently of one another from group i).
iii) —S—R^{VIII}, —S—C(S)—R^{VIII}, with R^{VIII} being able to be a radical from one of groups i) or ii).
iv) —O—R^{VIII}, —O—C(O)—R^{VIII}, with R^{VIII} being able to be a radical chosen from one of the groups i) or ii).

In connection with the abovementioned polymerizations which proceed by controlled-growth free-radical mechanisms, it is preferred to use initiator systems which further comprise additional radical initiators for the polymerization, especially thermally decomposing radical-forming azo or peroxo initiators. In principle, however, all customary initiators known for acrylates are suitable for-this purpose. The production of C-centred radicals is described in Houben-Weyl, Methoden der Organischen Chemie, Vol. E19a, p. 60 ff. These methods are employed preferentially. Examples of radical sources are peroxides, hydroperoxides, and azocompounds. A few nonexclusive examples of typical radical initiators that may be mentioned here include potassium peroxodisulphate, dibenzoyl peroxide, cumene hydroperoxide, cyclohexanone peroxide, cyclohexylsulphonyl acetyl peroxide, di-tert-butyl peroxide, azodiisobutyronitrile, diisopropyl percarbonate, tert-butyl peroctoate, and benzpinacol. In one very preferred variant, the radical initiator used is 1,1′-azobis(cyclohexylnitrile) (Vazo 88®, DuPont®) or 2,2-azobis(2-methylbutanenitrile) (Vazo 67°, DuPont®). Furthermore, it is also possible to use radical sources which release radicals only under UV irradiation.

In the conventional RAFT process, polymerization is generally carried out only to low conversions (WO 98/01478 A1), in order to obtain very narrow molecular weight distributions. Because of the low conversions, however, these polymers cannot be used as pressure sensitive adhesives and particularly not as hotmelt pressure sensitive adhesives, since the high residual monomer fraction adversely affects the adhesive technological properties, the residual monomers contaminate the solvent recyclate in the concentration process, and the corresponding self-adhesive tapes would exhibit very high outgassing.

The solvent is stripped off preferably in a concentrative extruder under reduced pressure, it being possible to use, for example, single-screw or twin-screw extruders for this purpose, which preferentially distil off the solvent in different or identical vacuum stages and which possess a feed preheater.

Tackifier resins may be admixed to the block copolymer PSAs of the invention. In principle, it is possible to use all resins soluble in the corresponding polyacrylate middle block P(B). Suitable tackifier resins include rosin and rosin derivatives (rosin esters, including rosin derivatives stabilized by, for example, disproportionation or hydrogenation) polyterpene resins, terpene-phenolic resins, alkylphenol resins, and aliphatic, aromatic and aliphatic-aromatic hydrocarbon resins, to name but a few. Primarily, the resins chosen are those which are compatible preferentially with the elastomer block. The weight fraction of the resins in the block copolymer is typically up to 40% by weight, more preferably up to 30% by weight.

For one special embodiment of the invention it is also possible to use resins compatible with the polymer block P(A).

It is also possible, optionally, to add plasticizers, fillers (e.g., fibres, carbon black, zinc oxide, titanium dioxide, chalk, solid or hollow glass beads, microbeads of other materials, silica, silicates), nucleators, blowing agents, compounding agents and/or aging inhibitors, in the form of primary and secondary antioxidants or in the form of light stabilizers, for example.

Generally, in connection with the additives, such as resins, extenders and plasticizers, care should be taken to ensure that these do not impair the outgassing characteristics. The substances used should therefore preferably be substances which even under a high temperature load possess a very low volatility.

The internal strength (cohesion) of the PSA is preferably produced by physical crosslinking of the polymer blocks P(A). The resulting physical crosslinking is typically thermoreversible. For irreversible crosslinking, the PSAs may additionally be crosslinked chemically. For this purpose, the acrylate block copolymer PSAs used for the reversible systems of the invention can optionally comprise compatible crosslinking substances. Examples of suitable crosslinkers include metal chelates, polyfunctional isocyanates, polyfunctional amines, and polyfunctional alcohols. Additionally, polyfunctional acrylates can be used with advantage as crosslinkers for actinic irradiation.

For the optional crosslinking with UV light, UV-absorbing photoinitiators are added to the polyacrylate-containing block copolymers employed in the systems of the invention. Useful photoinitiators which can be used to great effect are benzoin ethers, such as benzoin methyl ether and benzoin isopropyl ether, for example, substituted acetophenones, such as 2,2-diethoxyacetophenone (available as Irgacure 651° from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulphonyl chlorides, such as 2-naphthylsulphonyl chloride, and photoactive oximes, such as 1-phenyl-1,2-propanedione 2-(O-ethoxycarbonyl)oxime.

The abovementioned photoinitiators and others which can be used, including those of the Norrish I or Norrish II type, can contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholinyl ketone, aminoketone, azobenzoin, thioxanthone, hexaarylbisimidazole, triazine or fluorenone, it being possible for each of these radicals to be further substituted by one or more halogen atoms and/or one or more alkyloxy groups and/or one or more amino groups or hydroxyl groups. A representative overview is given by Fouassier: “Photoinitiation, Photopolymerization and Photocuring: Fundamentals and Applications”, Hanser-Verlag, Munich 1995. For further details, consult Carroy et al. in “Chemistry and Technology of UV and EB Formulation for Coatings, Inks and Paints”, Oldring (ed.), 1994, SITA, London.

In principle it is also possible to crosslink the pressure-sensitive adhesives used in accordance with the invention using electron beams. Typical irradiation devices which may be employed are linear cathode systems, scanner systems, and segmented cathode systems, in the case of electron beam accelerators. A detailed description of the state of the art, and the most important process parameters, can be found in Skelhorne, Electron Beam Processing, in Chemistry and Technology of UV and EB Formulation for Coatings, Inks and Paints, Vol. 1, 1991, SITA, London. The typical acceleration voltages are situated within the range between 50 kV and 500 kV, preferably between 80 kV and 300 kV. The radiation doses used range between 5 to 150 kGy, in particular between 20 and 100 kGy.

Self-Adhesive Tapes (Product Constructions)

The PSAs of the invention can be used as or for PSA tapes. PSA tapes of this kind may in particular have the following construction:

a] Single-layer adhesive sheets, consisting of one layer of the PSA of the invention comprising as its base polymer one or more block copolymers of the invention.

b] Multi-layer adhesive sheets, comprising one or more layers of the PSA of the invention, comprising as its base polymer one or more block copolymers of the invention.

a) Single-Layer Product Constructions

Because of the high cohesion of the acrylate block copolymers it is possible to produce acrylate block copolymer self-adhesive strips or sheets comprising a single layer a (FIG. 1) having a thickness of up to several millimetres. In view of the intrinsic UV stability, corresponding self-adhesive strips/sheets require very little if any light stabilizer. Embodiments with water-clear transparency and high light stability are therefore readily obtainable.

b) Multi-Layer Constructions

Additionally it is possible to utilize multi-layer self-adhesive strips/sheets having one or more layers of the PSA of the invention, examples being two-layer, three-layer, or else multi-layer systems (see FIG. 2 for a three-layer construction; FIG. 3 for a two-layer construction).

In addition it is possible to use adhesive tapes in the form of multi-layer constructions which include layers containing none of the aforedescribed acrylate block copolymers. Corresponding three-layer self-adhesive tapes contain, for example, one middle layer b and two outer layers a and a′ (FIG. 2). Layer b may comprise, for example, elastomers such as natural rubber, synthetic polyisoprene, polybutadiene or thermoplastic elastomers such as styrene block copolymers (e.g. styrene-isoprene-styrene, styrene-butadiene-styrene and/or their hydrogentaed analogues, styrene-ethylene/propylene-styrene and styrene-ethyleneibutylene-styrene) and/or the PMMA-containing polymers analogous to the aforementioned styrene block copolymers, i.e. poly(MMA-isoprene-MMA), poly(MMA-butadiene-MMA), poly(MMA-ethylene/propylene-MMA) and poly(MMA-ethylene/butylene-MMA), in unblended form or in a form blended with resins and/or other additives. In one very preferred embodiment the middle layer b may further comprise backing films, foams, webs, papers, metal foils and other backing materials commonly used in the production of pressure-sensitive adhesives.

The outer layers a and a′ are composed of PSAs of the invention, it being possible for a and a′ to have the same construction or a different construction. Outer layers of PSAs of the invention may have different or identical thicknesses and are typically at least 10 μm thick, more preferably at least 25 μm thick.

Envisaged further are adhesive tapes in the form of two-layer systems composed of two layers a and b (FIG. 3).

Layer b may be constructed, for example, from elastomers such as natural rubber or thermoplastic elastomers such as acrylate block copolymers or styrene block copolymers with polydiene middle blocks in unblended form or in a form blended with resins and/or other additives. Layer b is characterized in particular by a thickness of at least 10 μm, preferably by a thickness of not less than 25 μm and more preferably by a thickness of not less than 100 μm.

In one very preferred embodiment the middle layer b may also comprise backing films, foams, webs, papers, metal foils and further backing materials commonly used in the production of pressure-sensitive adhesives. In one embodiment very preferred for adhesive cable bandaging tapes the PSA tape is constructed from a web backing material and a PSA layer a. In order to comply with the requirement for low outgassing, in one preferred embodiment the backing material used ought also to be of a web likewise possessing low outgassing behaviour, such as Maliwalt, 80 g/m², 22 denier, from Cattano, for example.

The outer layer a is composed of a PSA of the invention. The outer layer typically has a thickness of not less than 10 μm, more preferably not less than 25 p.m.

Test Methods

A. Diesel Resistance

The PSA was laminated by the transfer method at 50 g/m² onto a Maliwatt web. A strip of this sample 2 cm wide is subsequently wound around a cable loom consisting of 10 cables and having a diameter of 10 mm, and stored at 60° C. for 48 hours. The cable loom is then bent into a U shape and immersed in the diesel fuel, with the end of the adhesive tape protruding from the fuel. The assembly as a whole is stored in the fuel for 5 minutes or for 24 h, after which the cable loom with adhesive tape is removed, the diesel fuel is allowed to drip off for 2 minutes and then the cable harness is bent around a mandrel having a diameter of 50 mm. The test is passed if there are no bags or creases, the adhesive does not detach, the PSA does not become spongy and there are also no instances of colour detachment.

B. Bond Strength

The peel strength (bond strength) was tested in accordance with PSTC-1. A 100 μm PSA layer is applied to a PET film 23 μm thick. A strip of this sample 2 cm wide is adhered to a steel plate by being rolled over back and forth three times using a 2 kg roller. The plate is clamped in and the self-adhesive strip is peeled off from its free end in a tensile testing machine under a peel angle of 180° and at a speed of 300 mm/min.

C. Shear Strength (C1: C2)

A strip of the adhesive tape 13 mm wide was applied to a smooth steel surface which had been cleaned three times with acetone and once with isopropanol. The area of application was 20 mm*13 mm (length*width). The adhesive tape was subsequently pressed onto the steel substrate four times, with an applied pressure of 2 kg. At 70° C. a 1 kg weight was fastened to the adhesive tape (C2), and at room temperature likewise a 1 kg weight (C1). The shear withstand times measured are reported in minutes and correspond to the mean of three measurements.

D. Gel Permeation Chromatogradhy (GPC)

The mean molecular weight M, and the polydispersity PD were determined by means of gel permeation chromatography. The eluant used was THF containing 0.1% by volume trifluoroacetic acid. Measurement was made at 25° C. The pre-column used was PSS-SDV, 5 μ, 10³ Å, ID 8.0 mm×50 mm. Separation was carried out using the columns PSS-SDV, 5 μ, 10³ and also 10⁵ and 10⁶ each with ID 8.0 mm×300 mm. The sample concentration was 4 g/l, the flow rate 1.0 ml per minute. Measurement was carried out against polystyrene standards.

E. Outgassing Behaviour

The volatile constituents were determined via GC-MS. The following instruments were used:

GC: Hewlett Packard HP 5890 SERIES 11 MS: Hewlett Packard HP 5989 A

For the measurement a DB-5 column was installed with a length of 60 m, an internal diameter of 0.25 mm and a film thickness of 1 μm. Measurement took place with a temperature programme of 50° C. (3 min)—150° C./min-260° C. (2 min). The carrier gas used was hydrogen (90 kPa) with a flow rate of 1 ml/min. The split ratio was 1:10. The test is passed if the amount of volatile fractions does not exceed 2000 μg/g.

F. Solvent Resistance

A double-sidedly pressure-sensitively adhesive tape specimen measuring 2.5×2.5 cm² is adhered between two steel plates by pressing at 8 kg for 1 minute. A test specimen and a reference specimen are equilibrated for 24 h at 23° C. and 50% relative atmospheric humidity. The test specimen is subsequently immersed for 10 minutes in a solvent mixture (50% toluene, 30% isooctane, 50% diisobutylene, 5% ethanol), dabbed off with absorbent cotton and left to stand for 5 minutes. In a dynamic shear test a determination is then carried out of the maximum force Fₘₐₓ which leads to failure of the bond. The results for the test specimen and for the reference specimen are compared. The test is passed if the measurement found for the test specimen is not lower than 10% of the value for the reference specimen.

Test Specimen Production

Preparation of a RAFT Regulator:

The regulator bis-2,2′-phenylethyl trithiocarbonate (formula VIII) was prepared starting from 2-phenylethyl bromide using carbon disulphide and sodium hydroxide in accordance with instructions from Synth. Comm., 1988, 18 (13), 1531. Yield: 72%: ¹H-NMR (CDCl₃), 5: 7.20-7.40 ppm (m, 10H); 3.81 ppm (m, 1H); 3.71 ppm (m, 1H); 1.59 ppm (d, 3H); 1.53 ppm (d, 3H).

Preparation of Nitroxides:

(a) Preparation of the Difunctional Alkoxyamine (XII):

Preparation took place in analogy to the experimental instructions from Journal of the American Chemical Society, 1999, 121(16), 3904. The starting materials used were 1,4-divinylbenzene and nitroxide (XIII). 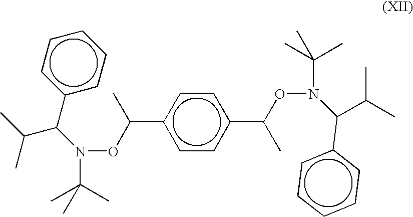
(b) Preparation of Nitroxide (XIII) (2,2,5-trimethyl-4-phenyl-3-azahexane 3-nitroxide):

Preparation took place in analogy to the experimental instructions from the Journal of the American Chemical Society, 1999, 121(16), 3904. 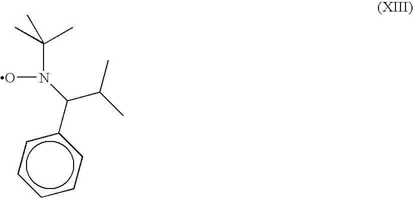
Preparation of polystyrene (A):

A 2 1 reactor conventional for free-radical polymerization is charged under a nitrogen atmosphere with 362 g of styrene and 3.64 g of bis-2,2′-phenylethyl trithiocarbonate regulator. This initial charge is heated to an internal temperature of 110° C. and initiation is carried out using 0.15 g of Vazo 676 (DuPont). After a reaction time of 10 hours 100 g of toluene are added. After a reaction time of 24 hours initiation takes place with a further 0.1 g of Vazo 670 and polymerization for a further 24 hours. During the polymerization there is a marked rise in the viscosity. This is compensated by adding 150 g of toluene as a final dilution after 48 hours.

For purification the polymer was precipitated in methanol, filtered off on a frit and then dried in a vacuum drying cabinet.

Gel permeation chromatography (test D) against polystyrene standards gave results of Mₙ=29300 g/mol and a polydispersity of 1.2.

### EXAMPLE 1

A reactor conventional for free-radical polymerizations was charged with 32 g of trithiocarbonate-functionalized polystyrene (A), 442 g of 2-ethylhexyl acrylate, 35 g of acrylic acid and 0.12 g of Vazo 670 (DuPont). After argon had been passed through the reactor for 20 minutes and the reactor had been degassed twice it was heated to 70° C. with stirring and polymerization took place for 24 hours.

To recover the polymer the batch was cooled to room temperature (RT), the block copolymer PS-P(EHA/AA)-PS was diluted to 50% with acetone and then coated using a conventional bar coater onto a Saran-primed PET backing 23 μm thick, which was then dried over 5 different stages at 60, 80, 100, 120 and 120° C. The average period of residence in each temperature zone was 80 seconds. The coatweight was 50 g/m². Testing then took place via methods B and C.

### EXAMPLE 2

A reactor conventional for free-radical polymerizations was charged with 32 g of trithiocarbonate-functionalized polystyrene (A), 442 g of 2-ethylhexyl acrylate, 17 g of acrylic acid and 0.12 g of Vazo 67® (DuPont). After argon had been passed through the reactor for 20 minutes and the reactor had been degassed twice it was heated to 70° C. with stirring and polymerization took place for 24 hours.

To recover the polymer the batch was cooled to room temperature (RT), the block copolymer PS-P(EHA/AA)-PS was diluted to 50% with acetone and then coated using a conventional bar coater onto a Saran-primed PET backing 23 μm thick, which was then dried over 5 different stages at. 60, 80, 100, 120 and 120° C. The average period of residence in each temperature zone was 80 seconds. The coatweight was 50 g/m². Testing then took place via methods B and C.

### EXAMPLE 3

A reactor conventional for free-radical polymerizations was charged with 3.2 kg of trithiocarbonate-functionalized polystyrene (A), 34.2 kg of n-butyl acrylate, 10 kg of isobornyl acrylate, 4.5 kg of acrylic acid and 0.12 g of Vazo 670 (DuPont). After argon had been passed through the reactor for 20 minutes and the reactor had been degassed twice it was heated to 70° C. with stirring and polymerization took place for 36 hours.

For the isolation the batch was cooled to RT and the block copolymer PS-P(BA/M)-PS was concentrated by means of a single-screw extruder (Bersdorff) with three devolatilizing units. The vacuum stages were 200 mbar, 60 mbar and 9 mbar. The throughput-of feed solution was 40 kg/h, the entry solution being preheated to 120° C. by means of a feed preheater. The exit temperature of the acrylate hotmelt PSA was approximately 130° C.

Subsequently steam was passed through the hotmelt PSA for 2 minutes, a water/impurities mixture was removed in a co-rotating twin-screw extruder (Welding Engineers) and then the adhesive was coated from the melt through a slot die onto a low-outgassing (<2 μg/g volatiles according to test method B), Saran-primed PET backing 23 μm thick. Subsequent heating took place in an IR zone at 120° C. for 80 seconds. The coatweight was 50 g/m². Testing then took place according to methods B and C.

### EXAMPLE 4

General procedure: A mixture of the alkoxyamine (XII) and the nitroxide (XIII) (10 mol % to alkoxyamine (XII)) is mixed with the monomer B (for the subsequent polymer block P(B)) degassed a number of times with cooling to −78° C. and then heated under pressure to 110° C. in a closed vessel. After a reaction time of 36 hours the monomer A (for the subsequent polymer block P(A)) is added and polymerization is continued at this temperature for a further 24 hours.

In analogy to the general polymerization procedure 0.739 g of the difunctional initiator (XII), 0.0287 g of the free nitroxide (XIII), 500 g of n-butyl acrylate (B) and 105 g of methyl methacrylate (A) were used. To isolate the polymer the batch was cooled to room temperature and the block copolymer PMMA-PBuA-PMMA was dissolved in 750 ml of dichloromethane and then precipitated from 6.0 1 of methanol (cooled to −78° C.) with vigorous stirring. The precipitate was filtered off on a cooled frit.

The product obtained was concentrated in a vacuum drying cabinet at 10 torr and 45° C. for 12 hours.

Characterization (test D): PMMA-PBuA-PMMA Mₙ=186 kg/mol (M_{w}/Mₙ=1.7).

The block copolymer was coated from the melt on to a Saran-primed PET backing film 23 μm thick. Subsequent heating took place in an IR zone at 120° C. for 80 seconds. The coatweight was 50 g/m². Testing was subsequently carried out in accordance with methods B and C.

To produce the specimens for test methods A and E, examples 1 to 4 were coated not onto PET film but instead onto a siliconized release paper with a silicone coatweight of 1.2 g/m² and then transfer-laminated onto a web backing (Maliwatt, 80 g/m², 22 denier, Cottano). Finally test methods A and E were carried out. Additionally, specimens for test method F were produced by coating polymers from examples 1 to 4 onto siliconized release paper with a silicone coatweight of 1.2 g/m² and covering them with a second ply of release paper.

Results

After the production of the test specimens, first the adhesive properties of examples 1 to 4 were determined. The results are listed in table 1. For the purpose of the assessment the bond strength to steel and the shear strength at different temperatures were determined.

TABLE 1

| Example | SWT RT/C1 | SWT 70° C./C2 | BS steel/B |
|---|---|---|---|
| 1 | +10 000 | 2085 | 5.1 |
| 2 | +10 000 | 880 | 4.7 |
| 3 | +10 000 | 355 | 4.6 |
| 4 | +10 000 | +10 000 | 4.4 |

SWT: shear withstand times in minutes
BS: bond strength in N/cm

From the measured values it is apparent that the PSAs of the invention all have a very good shear strength even without additional crosslinking by actinic irradiation. The adhesive requirements are therefore met.

In a further test the diesel resistance of these PSAs was investigated. For this purpose examples 1 to 4 were coated onto release paper and then transfer-laminated onto a Maliwatt web, which is used as backing material for numerous adhesive cable bandaging tapes. Test method A was then carried out with these specimens. From table 2 it is apparent that all specimens passed the diesel test and are therefore classed as diesel-resistant.

TABLE 2

| | Examples | | | |
|---|---|---|---|---|
| | 1 | 2 | 3 | 4 |
| | a. 5 m | a. 5 min/ | a. 5 min/ | a. 5 min/ |
| | in/a. 24 h | a. 24 h | a. 24 h | a. 24 h |
| Bagging | no/no | no/no | no/no | no/no |
| Creasing | no/no | no/no | no/no | no/no |
| Adhesive | no/no | no/no | no/no | no/no |
| detachment | | | | |
| Sponginess | no/no | no/no | no/no | no/no |
| Colour | no/no | no/no | no/no | no/no |
| detachment | | | | |
| Total | diesel- | diesel- | diesel- | diesel- |
| assessment | resistant | resistant | resistant | resistant |

a. 5 min = after 5 min;
a. 24 h = after 24 h

For suitability as a pressure-sensitive adhesive in the automotive sector another matter of high importance is the outgassing behaviour, since it is an aim on the part of carmakers to minimize the “new car smell” in a car. Therefore, additionally, a determination was made of the outgassing behaviour of these PSA tapes. The outgassing behaviour cannot be equated with the fogging test (see, for example, DE 198 07 752), since here detection is carried out of volatile constituents which cause the odour. In the fogging test the constituents detected tend to be which may deposit on the glass and originate, for example, from additions of resin. For testing, therefore, the outgassing behaviour was determined via Headspace GC. The measurement values are set out in table 3.

TABLE 3

| Example | Volatile fractions [μg/g] |
|---|---|
| 1 | 14 |
| 2 | 28 |
| 3 | 19 |
| 4 | 30 |

The values measured are situated at a very low level and therefore easily meet the requirements. Moreover, the outgassing behaviour can be controlled by the quality of concentration, and additional crosslinking does not give rise to any further volatile constituents. The volatile constituents detected were primarily hydrocarbon compounds, such as 2-methylpentane, 3-methylpentane, hexane, 2-methyl-1-propanol, 1-butanol, 2,4-dimethylpentane, cyclohexane and acetone, for example.

Finally attention ought also to be paid to the effect of organic solvents on the adhesive properties of the PSAs described here (table 4). Storage in organic solvents typically results in swelling and softening of the PSA and hence to an impairement in the cohesive properties. This becomes evident in a reduction in the holding power, which can be measured in dynamic shear tests. All of the example specimens, however, exhibit neither cohesive failure of the bond nor a dramatic drop in the adhesion forces. The samples can therefore be classified as solvent-resistant.

TABLE 4

| | Fₘₐₓ | Fₘₐₓ^{ref} | | |
|---|---|---|---|---|
| Example | [N/cm²] | [N/cm²] | | Result |
| 1 | 96.1 a | 101.8 | a | Solvent-resistant |
| 2 | 89.7 a | 84.3 | a | Solvent-resistant |
| 3 | 82.3 a | 79.9 | a | Solvent-resistant |
| 4 | 50.6 a | 53.0 | a | Solvent-resistant |

(a: adhesive fracture;
^{ref}reference specimen)

### LIST OF REFERENCE NUMERALS USED

a Layer of a first inventive PSA
a′ Layer of a second inventive PSA
b Backing layer

1. Pressure-sensitive adhesive comprising at least 50% by weight of at least one block copolymer formed from a comonomer composition comprising acrylic acid derivatives or methacrylic acid derivatives,
the block copolymer comprising a unit P(A)-P(B)-P(A) comprising a polymer block P(B) and two polymer blocks P(A);
the polymer blocks P(A) independently of one another representing homopolymer or copolymer blocks of monomers A, the polymer blocks P(A) each having a softening temperature in the range from +20° C. to +175° C.;
P(b) representing a homopolymer or copolymer block of monomers B, the polymer block P(B) having a softening temperature in the range from −130° C. to +10° C.; and
the polymer blocks P(A) and P(B) being not homogeneously miscible with one another.

2. Pressure-sensitive adhesive according to claim 1, wherein the block copolymer is a block copolymer of the formula
P(A)-P(B)-P(A) (I)
P(B)-P(A)-P(B)-P(A)-P(B) (II)
[P(B)-P(A)]ₙX (III) or
[P(B)-P(A)]ₙX[P(A)]ₘ (IV),
where n is an integer from 3 to 12, m is an integer from 3 to 12 and X is a polyfunctional branching region.

3. Pressure-sensitive adhesive according to claim 2 wherein all polymer blocks P(A) of the block copolymer have the same chain length.

4. Pressure-sensitive adhesive according to claim 1, wherein all polymer blocks P(B) of the block copolymer have the same chain length.

5. Pressure-sensitive adhesive according to claim 1, wherein all polymer blocks P(A) of the block copolymer have the same chemical structure.

6. Pressure-sensitive adhesive according claim 1, wherein all polymer blocks P(B) of the block copolymer have the same chemical structure.

7. Pressure-sensitive adhesive according to claim 1, wherein the block copolymer has a molar mass Mₙ of between 10 000 and 600 000 g/mol.

8. Pressure-sensitive adhesive according to claim 1, wherein the block copolymer has a polydispersity D of not more than 3.

9. Pressure-sensitive adhesive according to claim 1, wherein the block copolymer has a fraction of polymer blocks P(A) of between 5 and 49% by weight, based on the unit P(A)-P(B)-P(A).

10. Pressure-sensitive adhesive according to claim 1, wherein the ratio of the chain lengths of the polymer blocks P(A) to those of the polymer blocks P(B) is chosen such that the polymer blocks P(A) are present as a disperse phase in a continuous matrix of the polymer blocks P(B).

11. Pressure-sensitive adhesive according to claim 1, further comprising at least one diblock copolymer P(A)-P(B) where
the polymer block P(A) of the diblock copolymer independently of the polymer blocks of the unit P(A)-P(B)-P(A) represents homopolymer or copolymer blocks of the monomers A, the polymer blocks P(A) each having a softening temperature in the range from +20° C. to +175° C.; and
the polymer block P(B) of the diblock copolymer, independently of the polymer blocks of the unit P(A)-P(B)-P(A), represents homopolymer or copolymer blocks of the monomers B, the polymer blocks P(B) each having a softening temperature in the range from −130° C. to +10° C.

12. Pressure-sensitive adhesive according to claim 11, wherein the diblock copolymer has a molar mass Mₙ of between 5000 and 600 000 g/mol.

13. Pressure-sensitive adhesive according to claim 11, wherein the diblock copolymer has a polydispersity D of not more than 3.

14. Pressure-sensitive adhesive according to claim 11, wherein the diblock copolymer has a fraction of the polymer blocks P(A) of between 3 and 50% by weight, based on the diblock copolymer.

15. Pressure-sensitive adhesive according to claim 11, further comprising at least one polymer P′(A), the polymer P′(A) representing a homopolymer or copolymer of the monomers A and having a softening temperature in the range from +20° C. to +175° C.

16. Pressure-sensitive adhesive according to claim 15, wherein the polymer P′(A) is miscible with the polymer blocks P(A) of the block copolymer.

17. Pressure-sensitive adhesive according to claim 1, further comprising at least one polymer P′(B), the polymer P′(B) representing a homopolymer or copolymer of the monomers B and having a softening temperature in the range from −130° C. to +10° C.

18. Pressure-sensitive adhesive according to claim 17, wherein the polymer P′(B) is miscible with the polymer blocks P(B) of the block copolymer.

19. Pressure-sensitive adhesive according to claim 1, wherein polymer block P(B) is composed of a comonomer composition comprising, based on the polymer block P(B),
(a) 75 to 100% by weight of acrylic and/or methacrylic acid derivatives of the formula CH₂═CH(R¹)(COOR²) where R¹ is H or CH₃ and R² is H or linear, branched or cyclic, saturated or unsaturated alkyl radicals having from 1 to 30 carbon atoms; and
(b) 0 to 25% by weight of functionalized or non-functionalized vinyl compounds.

20. A pressure-sensitive adhesive tape formed of the pressure-sensitive adhesive of claim 1.

21. A pressure-sensitive adhesive tape comprising the pressure-sensitive adhesive of claim 1 and a backing.

22. The pressure-sensitive adhesive tape of claim 21, wherein the pressure-sensitive adhesive has been coated onto one or both sides of a backing.

23. A method for bandaging automotive cables, which comprises bandaging said cables with the pressure sensitive adhesive tape of claim 20.

24. A method for bandaging automotive cables, which comprises bandaging said cables with the pressure sensitive adhesive tape of claim 21.

25. A method for bandaging automotive cables, which comprises bandaging said cables with the pressure sensitive adhesive tape of claim 22.
